(19) United States
(12) Patent Application Publication
(10) Pub. No.: US 2007/0289835 A1
(43) Pub. Date: Dec. 20, 2007

(54) SYNCHRONIZER MECHANISM FOR TRANSMISSION

(75) Inventors: Hiroki HATORI, Nishio-shi (JP); Yuichi Fukuhara, Toyoake-shi (JP); Shiro Ogami, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI Co., Ltd., Nishio-shi (JP)

(21) Appl. No.: 11/765,860

(22) Filed: Jun. 20, 2007

(30) Foreign Application Priority Data
Jun. 20, 2006 (JP) 2006-170347

(51) Int. Cl. F16D 23/02

(52) U.S. Cl. 192/53.34

(57) ABSTRACT

A synchronizer mechanism for a transmission includes a clutch hub fixed to a transmission shaft, a sleeve fixed to the transmission shaft and splined to the clutch hub, a speed change gear including a movable conical surface, a synchronizer ring supported by the sleeve, a synchronous torque assisting member including a fixed conical surface, and a biasing member biasing the speed change gear to the clutch hub. The speed change gear is rotatably provided and axially movably mounted between the clutch hub and the synchronous torque assisting member. The movable conical surface and the fixed conical surface are mutually engageable. By axially actuating the synchronizer ring, a conical hole formed at the synchronizer ring is engaged with a conical surface formed at the speed change gear. Then the speed change gear moves against the biasing member and the movable conical surface and the fixed conical surface are mutually engaged.

### CROSS REFERENCE TO RELATED APPLICATIONS

This application is based on and claims priority under 35 U.S.C. § 119 to Japanese Patent Application 2006-170347, filed on Jun. 20, 2006, the entire content of which is incorporated herein by reference.

### FIELD OF THE INVENTION

The present invention relates to a synchronizer mechanism for synchronizing a rotation of a speed change gear, which is rotatably supported by a transmission shaft, and a rotations of a clutch hub and a sleeve, which are rotated with the transmission shaft, when changing a speed by shifting a gear of a multi-gear stage transmission. More particularly, the present invention relates to a structure of the synchronizer mechanism which is used to increase a synchronous torque.

### BACKGROUND

As a transmission provided with a synchronizer mechanism, a configuration described hereinbelow is generally known. That is, as illustrated in FIG. 4, a clutch hub 2 is coaxially inserted into a median diameter portion 1b of a transmission shaft 1 with splines. One side of the clutch hub 2 makes a contact with a step portion 1d, which is provided between the clutch hub 2 and a large diameter portion 1a of the transmission shaft 1 and the other side of the clutch hub 2 is fixed to the transmission shaft 1 with a stopper ring 1e, which is engaged with the median portion of a median diameter portion 1b of the transmission shaft 1. A first speed change gear 3 is rotatably provided at the median diameter portion 1b, which is adjacent to the clutch hub 2, and is fixed thereto with a washer and a stopper ring 1f. Further, a second speed change gear 4 is provided at the large diameter portion 1a, which is adjacent to the clutch hub 2, of the transmission shaft and is supported between the clutch hub 11 and a ring-shaped protruding portion 1c only to be rotatable. Each the speed change gear 3 and 4 is provided with a boss portion, respectively. Each the boss portion is provided at one side, which is adjacent to the clutch hub 2, of each the speed change gear 3 and 4, and is press-fitted into first and second gear piece 3a and 4a, respectively, so as to be integrally attached therewith and a conical surface is formed at an outer periphery of each the gear piece 3a and 4a. A first cone ring 6 is provided between the clutch hub 2 and the first gear piece 3a while a second cone ring 7 is provided between the clutch hub 2 and the second gear piece 4, so as to be rotatable with a predetermined angle and to be slightly movable in an axial direction. Each the conical ring 6 and 7 includes a conical hole, respectively, which makes a contact with the conical surface of each the gear piece 3a and 4a and frictionally engaged therewith. External splines are formed at an outer periphery of the clutch hub 2, while internal splines 5a are formed at an inner periphery of a sleeve 5 so as to be engageable with the external splines of the clutch hub 2 and movable in the axial direction. The sleeve 5 is operated to reciprocate in the axial direction by a shift fork 8, which is engaged with a circular groove formed at an outer periphery of the sleeve 5.

According to the transmission provided with a synchronizer mechanism described above, each the speed change gear 3 and 4 is rotatable relative to the shift 1 when the sleeve 5 is positioned in a neutral position as illustrated in FIG. 4. However, when the sleeve 5 is shifted towards the first speed change gear 3 by the shift fork 8, the first cone ring 6 also moves in the axial direction and the conical hole thereof is frictionally engaged with the conical surface of the first gear piece 3a and the internal splines 5a of the sleeve 5 are engaged with the external splines 6a of the first cone ring 6. Accordingly, the rotations of the transmission shaft 1 and the first speed change gear 3 are synchronized and then, the internal splines 5a of the sleeve 5 are engaged with the external splines 3b of the first gear piece 3a. Then the first speed change gear 3 is connected to the transmission shaft 1 so as to be integrally rotated therewith. In the same manner, when the sleeve 5 is shifted towards the second speed change gear 4 by the shift fork 8, the rotations of the transmission shaft 1 and the second speed change gear 2 are synchronized and the external splines 5a of the sleeve 5 axe engaged with the external splines 4b of the second gear piece 4a. Then the second speed change gear 4 is connected to the transmission shaft 1 so as to be integrally rotated therewith.

Further according to the transmission provided with a synchronizer mechanism described above, each the gear piece 3a and 4a is frictionally engaged with the cone ring 6 and 7, respectively, and a synchronous torque, for synchronizing the rotations of the transmission shaft 1 and the first speed change gear 1 or the rotations of the transmission shaft 1 and the second speed change gear 2, is generated. However, according to the transmission provided with synchronizer mechanism, the amount of the synchronous torque may not be always sufficient enough to synchronize the rotations of the transmission shaft 1 and the speed change gears, and the synchronizing operation may require time to be completed. Accordingly, the smooth gear change may not be efficiently obtained. JP2004-092863A (hereinafter, referred to reference 1) discloses an improvement for the efficiency of the synchronizing operation by increasing the synchronous torque. According to the reference 1, synchronizer rings (cone rings) are provided between a clutch hub, which integrally rotate with a rotation transmission shaft, and synchronizing cones (conical surfaces), which integrally rotates with gears (speed change gears). The synchronizing rings are configured with plural cone rings such as an outer cone ring, a middle cone ring, and an inner cone ring in order to increase a frictional area. Further, the middle cone ring is connected to the synchronizing cone to be relatively unrotatable, and the inner cone ring is connected to the outer cone ring to be unrotatable.

According to the reference 1, the amount of the torque, which is transmitted by the frictional engagement of each cone ring, is increased so that the amount of the synchronous torque is increased. However, the diameter of the outer cone ring, which has the largest diameter, is limited to be smaller than the inner diameter of the sleeve and accordingly, the amount of the synchronous torque may be limited. On the other hand, according to this type of the synchronizer for transmission, when a transmitting torque is large, the amount of the synchronous torque may need to be increased in accordance with the amount of the transmitting torque, in order to effectively shorten the time necessary for completing the synchronizing. Accordingly, it may be difficult to obtain a synchronous torque for the smooth gear change.

The present invention has been made in view of the above circumstances and provides a synchronizer mechanism for increasing a synchronous torque and for achieving a smooth gear change.

### SUMMARY OF THE INVENTION

According to an aspect of the present invention, a synchronizer mechanism for a transmission includes: a clutch hub which is integrally rotated with a transmission shaft and formed with external splines at an outer periphery of the clutch hub; a sleeve which is axially reciprocated by a shift fork and is formed with internal splines engageable with the external splines of the clutch hub so as to be axially movable relative to the external splines of the clutch hub; and a speed change gear which is rotatably supported by the transmission shaft and mounted thereon to be movable in an axial direction. The speed change gear includes a first end surface and a second end surface, and is coaxially integrally formed with a first conical surface, at an outer periphery of a boss portion formed at a center of a first end surface, and a second conical surface at a second end surface. The synchronizer mechanism for a transmission further includes: a synchronizer ring which is rotatably supported by the transmission shaft and mounted thereon to be slightly movable in the axial direction between the clutch hub and the speed change gear. The synchronizer ring is formed with a conical hole, which faces with the first conical surface of the speed change gear, at an inner periphery thereof and external splines at an outer periphery thereof. The synchronizer mechanism for a transmission still further includes: a synchronous torque assisting member which is coaxially fixed to the transmission shaft, placing a predetermined distance from the clutch hub in the axial direction, and is formed with a third conical surface so as to be frictionally engageable with the second conical surface of the speed change gear; and a biasing member which is provided between the synchronous torque assisting member and the speed change gear and is configured to bias the speed change gear to the clutch hub in the axial direction. The synchronizer ring is moved in the axial direction in accordance with an axial movement of the sleeve, and a rotation of the sleeve and a rotation of the speed change gear are synchronized by frictionally engaging the conical hole of the synchronizer ring with the first conical surface of the speed change gear and by engaging the external splines of the synchronizer ring with the internal splines of the sleeve. The second conical surface of the speed change gear and the third conical surface of the synchronous torque assisting member are not engaged with each other when the speed change gear is in contact with the clutch hub by the biasing member. Meanwhile the second conical surface of the speed change gear and the third conical surface of the synchronous torque assisting member become in contact with each other and are mutually frictionally engaged when the synchronizer ring is axially moved by the axial movement of the sleeve and the conical hole of the synchronizer ring is engaged with the first conical surface of the speed change gear, and then the speed change gear moves against the biasing member.

### BRIEF DESCRIPTION OF THE DRAWINGS

The foregoing and additional features and characteristics of the present invention will become more apparent from the following description considered with reference to the accompanying drawings, wherein;

FIG. 1 illustrates a cross-sectional view of an entire structure of a synchronizer mechanism for a transmission according to a first embodiment;

FIG. 2A1 is a cross-sectional view of a partial structure of the synchronizer mechanism for the transmission according to the first embodiment, illustrating a condition where a sleeve is positioned at a neutral position;

FIG. 2A2 is a partial enlarged cross sectional view of the synchronizer mechanism for the transmission taken along a line A-A in FIG. 2A1;

FIG. 2B1 is a cross-sectional view of a partial structure of the synchronizer mechanism for the transmission according to the first embodiment, illustrating a condition where the sleeve is shifted to be engaged with a synchronizer ring and a conical surface of a speed change gear is actuated to be engaged with a conical surface of a synchronous torque assisting member;

FIG. 2B2 is a partial enlarged cross-sectional view of the synchronizer mechanism for the transmission in FIG. 2B1, taken along a line in the same manner as the line A-A in FIG. 2A1;

FIG. 2C1 is a cross-sectional view of a partial structure of the synchronizer mechanism for the transmission according to the first embodiment, illustrating a condition where the sleeve is engaged with the synchronizer ring and the conical surface of the speed change gear is engaged with the conical surface of the synchronous torque assisting member;

FIG. 2C2 is a partial enlarged cross-sectional view of the synchronizer mechanism for the transmission in FIG. 2C1, taken along a line in the same manner as the line A-A in FIG. 2A1;

FIG. 3 is a cross-sectional view partially illustrating a synchronizer mechanism for a transmission according to a modified embodiment; and

FIG. 4 is a cross-sectional view partially illustrating a conventional synchronizer mechanism for a transmission.

### DETAILED DESCRIPTION

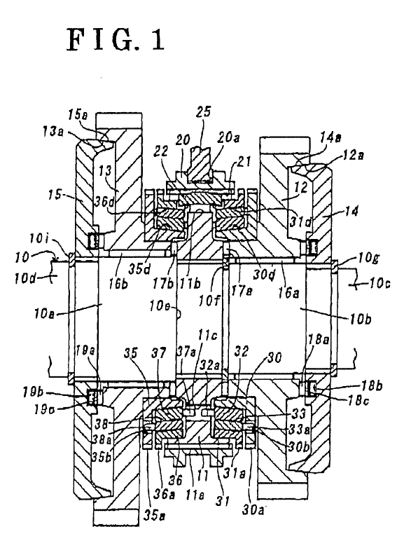

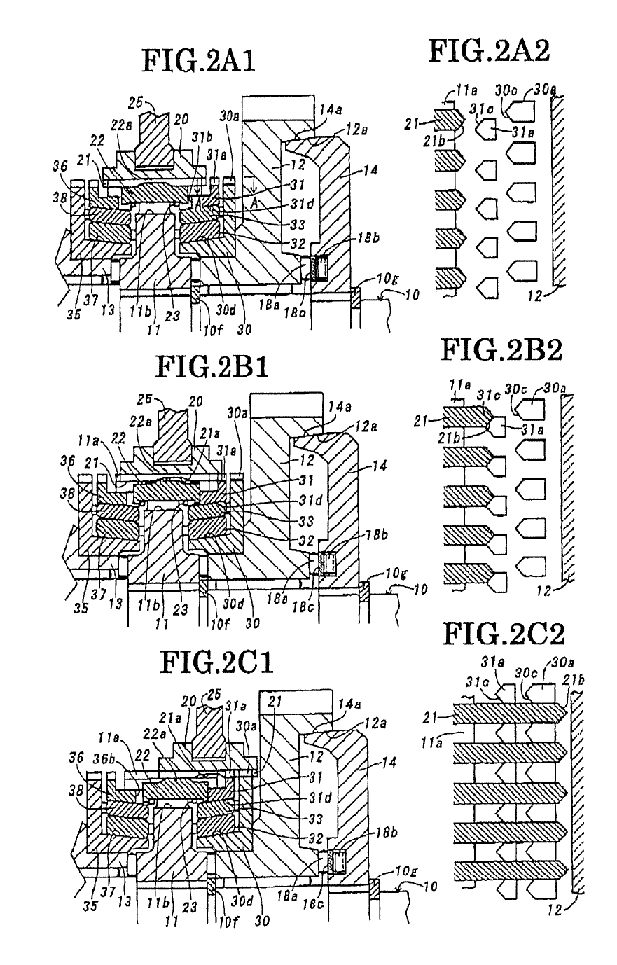

An embodiment of the present invention will be explained hereinbelow in accordance with attached FIGS. 1 and 2. As illustrated in FIG. 1, a synchronizer mechanism of a transmission includes a clutch hub 11 which integrally rotates with a transmission shaft 10, a first synchronizing piece 14 and a second synchronizing piece 15 (both serving as a synchronous torque assisting member) which also integrally rotate with the transmission shaft 10, and a sleeve 20 which is spline engaged with the outer periphery of the clutch hub 11 so as to be axially movable. Here, the transmission shaft 10 is represented by a drive shaft a counter shaft, or the like, for example. The synchronizer mechanism of the transmission further includes a first speed change gear 12 and a second speed change gear 13 which both are rotatably supported by the transmission shaft 10, a first synchronizer ring 31 which is rotatably provided between the first speed change gear 12 and the clutch hub 11, and a second synchronizer ring 36 which are rotatably provided between the second speed change gear 13 and the clutch hub 11.

The clutch hub 11 is coaxially spline-fitted to a median diameter portion 10b of the transmission shaft 10. A first end surface of the clutch hub 11 (i.e., axially left side of the clutch hub 11 in FIG. 1) is in contact with a step portion 10e which is provided between a large diameter portion 10a and the median diameter portion 10b of the transmission shaft 10, and a second end surface of the clutch hub 11 (i.e., axially right side of the clutch hub 11 in FIG. 1) is fixed to the transmission shaft 10 with a stopper ring 10f. The stopper ring 10f is engaged with the intermediate portion of the median diameter portion 10b. As described above, the clutch hub 11 is attached to the transmission shaft 10. The first synchronizing piece 14 is coaxially spline-fitted to a first small diameter portion 10c of the transmission shaft 10, a first small diameter portion 10c which is continuously provided to the median diameter portion 10b of the transmission shaft 10, and is in contact with a step portion (not denoted) between the median diameter portion 10b and the first small diameter portion 10c. Be first synchronizing piece 14 is fixed to the transmission shaft 10 with a stopper ring 10g and arranged axially at the right side of the clutch hub 11, placing a predetermined distance from the clutch hub 11. Meanwhile, the second synchronizing piece 15 is coaxially spline-fitted in a second small diameter portion 10d, which is continuously provided at the opposite side of the median diameter portion 10b integrally formed with the large diameter portion 10a. The second synchronizing piece 15 is further fixed to the transmission shaft 10 with a stopper ring 10i and arranged axially at the left side of the clutch hub 11, placing a predetermined distance from the clutch hub 11.

The first speed change gear 12 is formed or provided with boss portions at a center of a first end surface and at a second end surface thereof. The boss portions include a first boss portion and a second boss portion. The first and second boss portions of the first speed change gear 12 are rotatably supported by the median diameter portion 10b, which extends axially outwardly through the clutch hub 11, of the transmission shaft 10 via a needle roller bearing 16a. A thrust needle roller bearing 17a (serving as a second thrust bearing) is provided between the clutch hub 11 and a first boss portion formed at the center of the first end surface of the first speed change gear 12. The first boss portion of the first speed change gear 12 is coaxially integrally formed with a conical surface (serving as a first conical surface) at an outer periphery thereof. Meanwhile, a thrust needle roller bearing 18a (serving as a first thrust bearing) and a spring 18b (serving as a biasing member) are provided and arranged in series interposing a washer 18c between the first synchronizing piece 14 and the second boss portion formed at the second end surface of the first speed change gear 12. The spring 18b is represented by a ring-shaped steel plate bended into wave-shaped form, for example. The first speed change gear 12 is rotatably mounted on the transmission shaft 10 and provided between the clutch hub 11 and the first synchronizing piece 14. Further, the first speed change gear is slightly movably arranged in an axial direction and is elastically biased towards the clutch hub 11 by the spring 18b. The first speed change gear 12 is formed or provided with a rim portion at the second end surface thereof and an inner conical surface 12a (serving as a second conical surface) is formed at an inner periphery of the rim portion of the first speed change gear 12, an inner periphery which faces the first synchronizer piece 14. Meanwhile, an outer conical surface 14a (serving as a third conical surface) is formed at an outer periphery of the first synchronizing piece 14 so as to make a contact with the inner conical surface 12a. Here, the inner conical surface 12a serves as a movable conical surface and the outer conical surface 14a serves as a fixed conical surface. When the first speed change gear 12 is biased by the spring 18b and contacts with the clutch hub 11 via the thrust needle roller bearing 17a, there is a slight amount of distance between the inner conical surface 12a aid outer conical surface 14a so that the inner conical surface 12a and the outer conical surface 14a are not in contact with each other. On the other hand, when the first speed change gear 12 slightly moves towards the first synchronizing pieces 14 against a biasing force of the spring 18b, the inner conical surface 12a and the outer conical surface 14a comes in contact with each other and are frictionally engaged with each other.

The second speed change gear 13 is formed or provided with boss portions at a center of a first end surface and a second end surface thereof, and the boss portions include a first boss portion and a second boss portion, in the same manner as in the first speed change gear 12. The first and second boss portions of the second speed change gear 13 are rotatably supported by the large diameter 10a of the transmission shaft 10, which extends axially outwardly the clutch hub 11, via a needle roller bearing 16b. Between the clutch hub 11 and a first boss portion formed at the center of the first end surface of the second speed change gear 13, a thrust needle roller bearing 17b (serving as a second thrust bearing) is provided. The first boss portion of the second speed change gear 13 is coaxially integrally formed with a conical surface (serving as a first conical surface) at an outer periphery thereof. Meanwhile between the second synchronizing piece 15 and the second boss portion formed at the second end surface of the second speed change gear 13, a thrust needle roller bearing 19a (serving as a first thrust bearing) and a spring 19b (serving as a biasing member) are provided and arranged in series interposing a washer 19c. The spring 19b is represented by a ring-shaped steel plate bended into wave-shaped form, for example. As in the same manner with the first speed change gear 12, the second speed change gear 13 is rotatably mounted on the counter shaft 10 and provided between the clutch hub 11 and the second synchronizing piece 15. Further, the second speed change gear 13 is slightly movably arranged in the axial direction and is elastically biased towards the clutch hub 11 by the spring 19b. Further as in the same manner with the first speed change gear 12, the second speed change gear is formed or provided with a rim portion at the second end surface thereof and an inner conical surface 13a (serving as a second conical surface) is formed at an inner periphery of the rim portion of the second speed change gear 13, an inner periphery which faces the second synchronizer piece 15. Further, the second speed change gear is slightly movably arranged in the axial direction and is elastically biased towards the clutch hub 11 by the spring 19b, while an outer conical surface 15a (serving as a third conical surface) is formed at an outer periphery of the second synchronizing piece 15 so as to make a contact with the inner conical surface 13a. Here, the inner conical surface 13a serves as a movable conical surface and the outer conical surface 15a serves as a fixed conical surface. When the second speed change gear 13 is biased by the spring 19b and contacts with the clutch hub 11 via the thrust needle roller bearing 17b, here is a slight amount of distance between the inner and outer conical surfaces 13a and 15a so that the inner conical surface 13a and the outer conical surface 15a are not in contact with each other. On the other hand, when the second speed change gear 13 slightly moves towards the second synchronizing pieces 14 against the biasing force of the spring 19b, the inner conical surface 13a and the outer conical surface 15a comes in contact with each other and are frictionally engaged with each other. Each the speed change gear 12 and 13 is always engaged with speed change gear (sot illustrated) respectively provided to a transmission shaft (not illustrated), which is supported in parallel to the transmission shaft 10.

The sleeve 20 is provided with internal splines 21 at the inner periphery thereof. The internal splines 21 are slidably engaged with external splines 11a, which are formed at an outer periphery of the rim portion of the clutch hub 11, in the axial direction. Accordingly, the sleeve 20 is operated to reciprocate in the axial direction by the shift fork 25 which is engaged with a circular groove 20a formed at an outer periphery of the sleeve 20. The outer periphery of the clutch hub 11 is formed with three cut out portions 11b in a circumferential direction and the cutout portions 11b therein are provided with a shifting key 22 of which both the sidewalls are slidably contacted with inner sidewalls of the cutout portions 11b, in the axial and radial direction. The shifting key 22 is elastically biased by a ring-shaped spring 23 radially outwardly. With reference to FIG. 1 and FIG. 2A1, when the sleeve 20 is positioned in an axially intermediate portion, a protruding portion 22a, which is formed or provided in longitudinally intermediate portion of the shifting key 22 aid which includes low inclined portions formed at both sides thereof, is engaged with a concave portion 21a, which includes low inclined portions formed at both sides thereof and which is formed in longitudinally intermediate portion of the internal splines 21 of the sleeve 20. A cylindrical portion of a first gear piece 30, of which its cross-sectional shape is “L”, is integrally fixed with the first boss portion, which protrudes towards the clutch hub 11, of the first speed change gear 12 by press fitting or the like. In the same manner, a cylindrical portion of a second gear piece 35, of which its cross-sectional shape is also “L”, is integrally fixed with the first boss portion, which also protrudes towards the clutch hub 11, of the second speed change gear 13 by press fitting or the like. A conical surface 30d is formed at an outer periphery of the cylindrical portion, which extends towards the clutch hub 11, of the first gear piece 30 while an external splines 30a, which is engageable with the internal splines 21 of the sleeve 20, is formed at a flange portion, which extends radially inwardly, of the first gear piece 30. In the same tanner, a conical surface 35d is formed at an outer periphery of the cylindrical portion, which extends towards the clutch hub 11, of the second gear piece 35 while an external splines 35a, which is engageable with the internal splines 21 of the sleeve 20, is formed at a flange portion, which extends radially inwardly, of the second gear piece 35.

At the both inner peripheral surfaces of the rim portion of the clutch hub 11, each cylindrical portion of the first synchronizer ring 31 and of the second synchronizer ring 36, of which its cross-sectional shape is “L”, is inserted into and slidably supported in the axial direction. Each the inner periphery of the cylindrical portion of the first synchronizes ring 31 and of the second synchronizer ring 36 is formed with a conical hole 31d and 36d, respectively. Meanwhile each the outer periphery of the flange portion, which respectively extends radially inwardly, of each the first and second synchronizer ring 31 and 36 is respectively formed with external splines 31a and 36a which are engageable with the internal splines 21 of the sleeve 20. The first and second synchronizer rings 31 and 36 are each formed, at its end surface of the cylindrical portion, with cutout portions 31b and 36b, respectively. Each cutout portion 31b and 36b has a wider width than a width of the shifting key 22 in a circumferential direction. Both ends of the shifting key 22 are positioned in the cutout portions 31b and 36b of the synchronizer rings 31 and 36. Therefore, the synchronizer rings 31 and 36 are rotated with the clutch hub 11 and the sleeve 20 having a predetermined angle in the circumferential direction, in a situation where the distance between the external splines 31a and 36a is matched with the internal splines 21 of the sleeve 20.

An inner middle ring 32 and an outer middle ring 33 are provided between the conical surface 30d of the first gear piece 30 and the conical hole 31d of the first synchronizer ring 31 which are mutually facing each other. Each inner middle ring 32 and the outer middle ring 33 has approximately regular thickness and includes an outer conical surface, formed at an outer periphery thereof, and an inner conical hole, formed at an inner periphery thereof, respectively. The conical hole of the inner middle ring 32 is contactable with the conical surface 30d of the first gear piece 30. The inner conical surface of the outer middle ring 33 is contactable with the outer conical hole 31d of the first synchronizer ring 31. The outer conical surface of the inner middle ring 32 and the inner conical hole of the outer middle ring 33 are mutually contactable. The inner middle ring 32 is formed or provided with plural protruding portions 32a which axially protrude only towards the clutch hub 11. The protruding portions 32a of the inner middle ring 32 are engaged with plural through-holes 11c which are formed at the clutch hub 11 and accordingly, the inner middle ring 32 is rotated with the clutch hub 11. Meanwhile, the outer middle ring 33 is formed or provided with plural protruding portions 33a which axially protrude only towards the first speed change gear 12. The protruding portions 33a of the outer middle ring 33 are engaged with plural through-holes 30b which are formed at the first gear piece 30 and accordingly, the outer middle ring 33 is rotated with the first speed change gear 12.

In the same manner, an inner middle ring 37 and an outer middle ring 38 are provided between the conical surface 35d of the second gear piece 35 and the conical hole 36d of the second synchronizer ring 36 which are mutually facing with. Each the inner middle ring 37 and the outer middle ring 38 has approximately regular thickness and includes an outer conical surface and an inner conical hole, respectively, in the same manner as in the middle rings 32 and 33. The inner conical hole of the inner middle ring 37 is contactable with the outer conical surface 35d of the second gear piece 35. The outer conical surface of the outer middle ring 38 is contactable with the inner conical hole 36d of the second synchronizer ring 36. The conical surface of the inner middle ring 37 and the conical hole of the outer middle ring 38 are mutually contactable. The inner middle ring 37 is formed or provided with plural protruding portions 37a which axially protrude only towards the clutch hub 11. The protruding potions 37a of the inner middle ring 37 are engaged with the plural through-holes 11c formed at the clutch hub 11 and accordingly, the inner middle ring 37 is rotated with the clutch hub 11. Meanwhile, the outer middle ring 38 is formed or provided with plural protruding portions 38a which axially protrude only towards the second speed change gear 13. The protruding portions 38a of the outer middle ring 38 are engaged with plural through-holes 35b which are formed at the second gear piece 35 and accordingly, the outer middle ring 38 is rotated with the second speed change gear 13.

Next, an operation of the synchronizer mechanism for the transmission according to above-described embodiment will be explained hereinbelow. The operations described below are operated in a manner where a clutch (not illustrated), which is provided at a drivetrain including the first and second speed change gear 11 and 12, is in a disengagement state. When the sleeve 20 is positioned in a neutral position as illustrated in FIG. 1 and FIG. 2A1, the first and second speed change gears 12 and 13 are biased by the springs 18b and 19b, respectively. Further, the first and second speed change gears 12 and 13 make a contact with the clutch hub 11 via thrust needle roller bearings 17a and 17b, respectively. In the mean time, a space is respectively opened between an end of the shifting key 22 and a bottom portion of the cutout portions 31b formed at the first synchronizer ring 31, and between an end of the shifting key 22 and a bottom portion of the cutout portions 36b formed at the second synchronizer ring 36. In this case, a slight space is respectively opened between the conical surface and conical hole of each the first gear piece 30, the first synchronizer ring 31, the inner middle ring 32 and of the outer middle ring 33. Further a slight space is opened between the inner conical surface 12a of the first speed change gear 12 and the outer conical surface 14a of the first synchronizer ring 14. Accordingly, each the first speed change gear 12 and the second speed change gear 13 is rotatable relative to the transmission shaft 10.

When the sleeve 20 is positioned in the neutral position, normally rotation speeds of the transmission shaft 10, the clutch hub 11, and of the sleeve 20 are different form a rotation speed of the first speed change gear 12. Accordingly, as illustrated in FIG. 2A2, which illustrates a partial enlarged cross sectional view of the synchronizer mechanism for the transmission taken along a line A-A in FIG. 2A1, the first synchronizer ring 31 is axially circumferentially shifted from an intermediate position, at which the spaces between the external splines 31a of the first synchronizer ring 31 are engaged with the internal splines 21 of the sleeve 20, at a predetermined play in accordance with a relative rotating direction of the transmission shaft 10, the clutch hub 11, the sleeve 20, and of the first speed change gear 12, and is rotated with the clutch hub 11. In the same manner, the second synchronizer ring 36 is axially circumferentially shifted from an intermediate position, at which the spaces between the external splines 36a of the second synchronizer ring 36 are engaged with the internal splines 21 of the sleeve 20, with a predetermined play and is rotated with the clutch hub 11.

In this case, when the sleeve 20 is actuated towards the first synchronizing piece 14 by the shift fork 25, the protruding portion 22a of the shifting key 22 is pressed to the convex portion 21a, formed at the center portion of the internal splines 21, by the spring 23. Accordingly, the shifting key 22 is also actuated with the sleeve 20 which is actuated by the shift fork 25. Then, an end portion of the shifting key 22 makes a contact with the bottom portion of the cutout portions 31b formed at the first synchronizer ring 31 and the first synchronizer ring 31 is pressed towards the first speed change gear 12. Therefore, the first synchronizer ring 31 is slightly actuated towards the first speed change gear 12. When the conical surfaces and the conical holes of each the first gear piece 30, the first synchronizer ring 31, the inner middle ring 32 and the outer middle ring 33 mutually make a contact, frictional force is generated at each contact portion and a synchronous torque, which synchronizes the clutch hub 11 with the first speed change gear 12, is generated by the frictional force. Once the synchronizing between the clutch hub 11 and the first speed change gear 12 is started by the synchronous torque, the actuation of the first synchronizer ring is paused.

As illustrated in FIG. 2B1, when the sleeve 20 is actuated by the shift fork 25 so as to be closer to the first synchronizing piece 14, an inclined surface of the protruding portion 22a slides on an inclined surface of the convex portion 21a against the biasing force of the spring 23 and the axial pressing force exerted to the first synchronizer ring 31 from the shifting key 22 is gradually increased. When the sleeve 20 is actuated by the shift fork 25 so as to be further closer to the first synchronizing piece 14, chamfers 21b of the sleeve 20 make a contact with chamfers 31c of the first synchronizer ring 31, as illustrated in FIG. 2B2. Here, the chamfers 21b are formed at the edge of the internal splines 21 of the sleeve 20 and the chamfers 31c are formed at the edge of the external splines 31a of the first synchronizer ring 31. When an axial pressing force generated by a contact of the chamfers 21b and the chamfers 31c exceeds a predetermined limit, the first speed change gear 12 moves towards the first synchronizing piece 14 against the pressing force of the spring 18b and the inner conical surface 12a of the first speed change gear 12 and the outer conical surface 14a of the first synchronizing piece 14 are mutually contacted. Then, a synchronous torque generated between the conical surfaces 12a and 14a is added to the synchronous torque generated between the conical surface and conical hole of each the first gear piece 30, the first synchronizer ring 31, the inner middle ring 32 and of the outer middle ring 33. Therefore, the synchronous torque is rapidly increased and a synchronizing of the first speed change gear 12 and the clutch hub 11 rapidly progresses. Then, each synchronizing between the clutch hub 11 and the first speed change gear 12, and between the first synchronizing piece 14 and the first speed charge gear 12, is completed. Consequently, the torque generated between the sleeve 20 and the first synchronizer ring 31 is not generated and, as illustrated in FIG. 2C1 and FIG. 2C2, the internal splines 21 of the sleeve 20 thrust through the external splines 31a of the first synchronizer ring 31 in terms of the chamfers 21b and 31c and are engaged with the external splines 31a of the first synchronizer ring 31. Then, the sleeve 20 moves towards the first speed change gear 12 and further, the internal splines 21 of the sleeve 20 thrust through chamfers 30c of the first gear piece 30, which is integrally fixed to the first speed change gear 12, and are engaged with the external splines 30a of the first gear piece 30. Accordingly, the transmission shaft 10 and the first speed change gear 12 are connected so as to be integrally rotated.

On the contrary, when the sleeve 20 is actuated towards the second synchronizing piece 15 from the neutral position illustrated in FIGS. 1 and 2A1 by the shift fork 25, the shifting key 22 makes a contact with the second synchronizer ring 36. Then the chamfers 21b provided at the edge of the internal splines 21 are contacted with chamfers 36c provided at the edge of the external splines 36a of the second synchronizer ring 36 and the position of the shifting key 22 is determined. When the sleeve 20 is further actuated by the shift fork 25, the second speed change gear 13 moves towards the second synchronizing piece 15 against a pressing force of the spring 19b. Then the inner conical surface 13a of the second speed change gear 13 is contacted with the outer conical surface 15a of the second synchronizing piece 15 and a synchronizing of the clutch hub 11 and the second speed change gear 13 rapidly progresses. Then, each the synchronizing of the clutch hub 11 and the second speed change gear 13, and of the second synchronizing piece 15 and the second speed change gear 13 is completed. When the sleeve 20 further moves towards the second speed change gear 13, the internal splines 21 of the sleeve 20 are engaged with the external splines 36a of the second synchronizer ring 36 and further, the internal splines 21 of the sleeve 20 are engaged with the external splines 35 of the second gear piece 35. Accordingly, the transmission shaft 10 and the second speed change gear 13 are connected so as to be integrally rotated.

When the first speed change gear 12 is moved to be away from the corresponding first synchronizing piece 14 from the above-described state where the first speed change gear 12 is integrally rotated with the transmission shaft 10, the internal splines 21 of the sleeve 20 are separated from the external splines 30a of the first gear piece 30 and the external splines 31a of the first synchronizer ring 31. Then, the sleeve 20 is returned to the neutral position again, as in FIGS. 1 and 2A1. In the same manner, when the when the second speed change gear 13 is moved to be away from the corresponding second synchronizing piece 15 from the above-described state where the second speed change gear 13 is integrally rotated with the transmission shaft 10, the internal splines 21 of the sleeve 20 are separated from the external splines 35a of the second gear piece 35 and the external splines 36a of the second synchronizer ring 36. Then, the sleeve 20 is returned to the neutral position again, as in FIGS. 1 and 2A1.

According to the above-described embodiment, the synchronous torque which synchronizes the clutch hub 11 and the first speed change gear 12 is a total torque of a first synchronous torque, which is generated by the frictional engagement between the conical surface and the conical hole of each the first gear piece 30, the first synchronizer ring 31, the inner middle ring 32 and of the outer middle ring 33, and a second synchronous torque, which is generated by the frictional engagement between the inter conical surface 12a formed at the first speed change gear 12 and the outer conical surface 14a of the first synchronizing piece 14. In the same manner, the synchronous torque which synchronizes the clutch hub 11 and the second speed change gear 13 is a total torque of a first synchronous torque, which is generated by the frictional engagement between each the conical surfaces and the conical holes of the second gear piece 35, the second synchronizer ring 36, the inner middle ring 37 and the outer middle ring 38, and a second synchronous torque, which is generated by the frictional engagement between the inter conical surface 13a formed at the second speed change gear 13 and the outer conical surface 15a of the second synchronizing piece 15. On the other hand, a synchronous torque according to the aforementioned conventional art is only of the first synchronous torque. That is, according to the above-described embodiment, the synchronous torque is totally increased as the second synchronous torque is added. Consequently, the time required to complete the synchronizing is effectively reduced and the gear change may be smoothly achieved in comparison with the known art.

Further, according to the above-described embodiment, the thrust needle roller bearing 17a is provided between the first boss portion of the first speed change gear 12 and the clutch hub 11, and the thrust needle roller bearing 18a and spring 18b are provided in series between the second boss portion of the first speed change gear 12 and the first synchronizing piece 14 interposing the washer 18c. In the same manner, the thrust needle roller bearing 17b is provided between the first boss portion of the second speed change gear 13 and the clutch hub 11, and the thrust needle roller bearing 19a and spring 19b are provided in series between the second boss portion of the second speed change gear 13 and the second synchronizing piece 15 interposing the washer 19c. Therefore, frictional losses associated with the relative rotations between each the speed change gear 12, 13 and the clutch hub 11, or between each the speed change gear 12,13 and each synchronizing piece 14 and 15 are reduced by the thrust needle roller bearings 17a, 17b, 18a and 19a. Accordingly, when each the speed change gears 12 and 13 do not make a contact with the clutch hub 11 by the sleeve 20 and when the speed change gears 12 and 13 are relatively rotated with clutch hub 11 and with each the synchronizing piece 14 and 15, driving forces are lost less in this condition.

In a case where a transmitting torque is large, this type of synchronizing apparatus for transmission requires to increase the synchronous torque in accordance with the amount of the transmitting torque. According to the above-described embodiment, the inner conical surface 12a, which makes contact with the synchronizing piece 14, is formed at the first speed change gear 12 and the inner conical surface 13a, which makes a contact with the second synchronizing piece 15, is formed at the second speed change gear 13. Therefore, when a size of each the speed change gears 12 and 13 is of a large diameter, the movable conical surfaces 12a and 13a of the first and second speed change gears 12 and 13 are configured to be large diameter and the second synchronous torque, which is generated by the frictional engagement between the movable conical surface 12a of the first speed change gear 12 and the outer conical surface 14a of the first synchronizing piece 14, or between the movable conical surface 13a of the second speed change gear 13 and the outer conical surface 15a of the second synchronizing piece 15. Accordingly, the gear change may be smoothly achieved even when the transmitting torque is large.

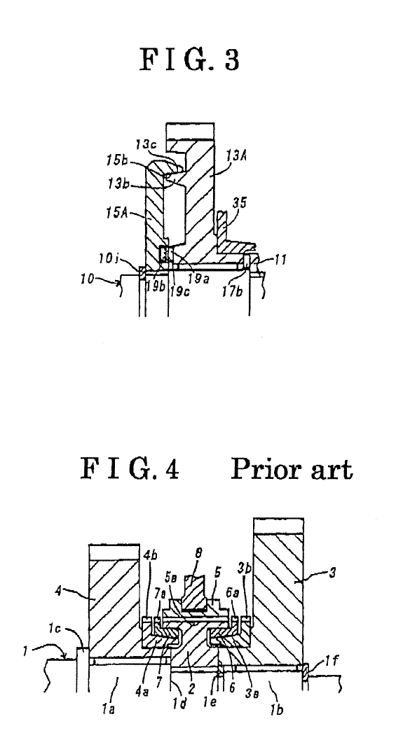

Further, according to the above-described embodiment, each movable conical surface 12a and 13a formed at the speed change gears 12 and 13 serves as inner conical surface, while each the fixed conical surface 14a and 15a formed at the synchronizing pieces 14 and 15 serves as outer conical surface, respectively. Thus, a size of the diameters of the conical surfaces 12a and 14a, and of the diameters of the conical surfaces 13a and 15a, which contact with each other between a range of a predetermined diameter of the speed change gears 12 and 13, can be the maximum possible. Therefore, an obtained synchronous torque can be the maximum possible. The above-described embodiment according to the present invention may be modified as described hereinbelow. As illustrated in FIG. 3, a movable conical surface formed at a speed change gear may serve as an outer conical surface, while a fixed conical surface formed at a synchronizing piece may serve as an inner conical surface. In this modified embodiment, a circumferential protrusion 13b is formed or provided at an end surface of a speed change gear 13A where faces with a synchronizing piece 15A in coaxial direction of the transmission shaft 10. Further an outer conical surface (movable conical surface) 13c is formed or provided at the outer periphery of the circumferential portion 13b and inner conical surface (fixed conical surface) 15b is formed or provided at the inner periphery of a rim portion of the synchronizing piece 15A.

In this modified embodiment, when the speed change gear 13A is biased by the spring 18b and is contacted with the clutch hub 11 via the thrust needle roller bearing 17b, the outer conical surface 13c is slightly separated from the inner conical surface 15b and both the conical surfaces are not contacted with each other. However, when the speed change gear 13A is slightly moved towards the synchronizing piece 15A against the biasing force of the spring 19b, the conical surfaces 13c and 15b mutually make a contact and frictionally engaged with each other. According to the modified embodiment, the diameters of each the conical surfaces 13c and 15b, which are mated with each other, is smaller compared to the first embodiment described with reference to FIGS. 1 and 2. Accordingly, a maximum value of the synchronous torque is reduced. However, this modified embodiment is applicable except in a situation where the transmitting torque is too large. The other components and operations herein are used in the same manner as the first embodiment described with FIGS. 1 and 2. Accordingly, such components and operations in the same manner as the first embodiment are denoted with the same reference numerals and are not described specifically.

According to the first embodiment, the inner middle ring 32 and the outer middle ring 33 are provided between the conical surface 30d of the first gear piece 30 and the conical hole 31d of the first synchronizer ring 31 while the inner middle ring 37 and the outer middle ring 38a are provided between the conical surface 35d of the second gear piece 35 and the conical hole 36d of the second synchronizer ring 36. Accordingly, the torque transmitted between the first gear piece 30 and the first synchronizer ring 31, or between the second gear piece 35 and the second synchronizer ring 36, is increased and therefore, the synchronous torque is increased. However, the above-described embodiment according to the present invention may be member modified as described hereinbelow. The conical surfaces 30d, 35d may be directly connected to the conical holes 31d, 36d of the synchronizer rings 31, 36 without providing the middle rings.

According to the synchronizer mechanism for the transmission as described above, the conical hole of the synchronizer ring is engaged with the conical surface of the speed change gear and the speed change gear is also actuated against an elastic biasing force of the biasing member by axially actuating the synchronizer ring with the sleeve. Then, the movable conical surface formed at the speed change gear is engaged with the fixed conical surface of the synchronous torque assisting member and as a consequence, the synchronous torque for synchronizing the rotation of the transmission shaft and of the speed change gear becomes a total torque of a first synchronous torque, which is generated by the frictional engagement between the conical surfaces of the speed change gear and the conical holes of the synchronous torque assisting member, and a second synchronous torque, which is generated by the frictional engagement between the movable conical surface of the speed change gear and the fixed conical surface of the synchronous torque assisting member. Therefore, the synchronous torque for synchronizing the rotation of the transmission shaft and of the speed change gear is increased because of the second synchronous torque, which is not generated conventionally, and the time necessary for completing the synchronizing is effectively shorten. Consequently, the smooth gear change may be obtained. Further, when the size of the speed change gear is of a large diameter, the movable conical surface of the speed change gear may be configured to be large diameter and the second synchronous torque, which is generated by the frictional engagement between the movable conical surface and the fixed conical surface, may be increased. Accordingly, the gear change further may be smoothly achieved even when the size of the speed change gear is of a large diameter.

It is preferable that the biasing member includes a spring provided between the speed change gear and the synchronous torque assisting member.

It is further preferable that the first thrust bearing is arranged in series with the spring between the speed change gear and the synchronous torque assisting member.

It is still further preferable that the second thrust bearing is provided between the speed change gear and the clutch hub.

According to the described subject matter, the frictional losses associated with the relative rotation generated between the speed change gear and the clutch hub, and between the speed change gear and the synchronous torque assisting member, are reduced by the thrust needle roller bearings. Therefore, the speed change gear is not directly connected to the clutch hub. Consequently, the driving forces, upon the speed change gear relatively being rotating with the clutch hub and the synchronous torque assisting member, may be lost less.

It is still further preferable that the second conical surface includes a movable conical surface formed at a rim portion of the speed change gear, and the third conical surface includes a fixed conical surface formed at an outer periphery of the synchronous torque assisting member.

According to the described subject matter, both the diameter of the movable conical surface of the speed change gear and of the fixed speed change gear of the synchronous torque assisting member may be configured to be large. Consequently, the synchronous torque may be quite large and the gear change further may be smoothly achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive, variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A synchronizer mechanism for a transmission, comprising:
a clutch hub integrally rotated with a transmission shaft and formed with external splines at an outer periphery of the clutch hub;
a sleeve axially reciprocated by a shift fork, the sleeve being formed with internal splines engageable with the external splines of the clutch hub so as to be axially movable relative to the external splines of the clutch hub;
a speed change gear rotatably supported by the transmission shaft and mounted thereon to be movable in an axial direction, the speed change gear being coaxially integrally formed with a first conical surface at an outer periphery of a boss portion formed at a center of a first end surface of the speed change gear, the speed change gear being formed with a second conical surface at a second end surface of the speed change gear;
a synchronizer ring rotatably supported by the transmission shaft and mounted thereon to be slightly movable in the axial direction between the clutch hub and the speed change gear, the synchronizer ring being formed with a conical hole at an inner periphery thereof and external splines at an outer periphery thereof, the conical hole of the synchronizer ring facing the first conical surface of the speed change gear;
a synchronous torque assisting member coaxially fixed to the transmission shaft placing a predetermined distance from the clutch hub in the axial direction, the synchronous torque assisting member being formed with a third conical surface so as to be frictionally engageable with the second conical surface of the speed change gear; and
a biasing member provided between the synchronous torque assisting member and the speed change gear, the biasing member configured to bias the speed change gear to the clutch hub in the axial direction, wherein
the synchronizer ring is moved in the axial direction in accordance with an axial movement of the sleeve, and a rotation of the sleeve and a rotation of the speed change gear are synchronized by frictionally engaging the conical hole of the synchronizer ring with the first conical surface of the speed change gear and by engaging the external splines of the synchronizer ring with the internal splines of the sleeve, and wherein
the second conical surface of the speed change gear and the third conical surface of the synchronous torque assisting member are not engaged when the speed change gear is in contact with the clutch hub by the biasing member, the second conical surface of the speed change gear and the third conical surface of the synchronous torque assisting member become in contact with each other and are mutually frictionally engaged when the synchronizer ling is axially moved by the axial movement of the sleeve and the conical hole of the synchronizer ring being engaged with the first conical surface of the speed change gear, and then the speed change gear moves against the biasing member.

2. The synchronizer mechanism for the transmission according to claim 1, wherein, the biasing member includes a spring provided between the speed change gear and the synchronous torque assisting member.

3. The synchronizer mechanism for the transmission according to claim 2, wherein a first thrust bearing is arranged in series with the spring between the speed change gear and the synchronous torque assisting member.

4. The synchronizer mechanism for the transmission according to claims 1, wherein, a second thrust bearing is provided between the speed change gear and the clutch hub.

5. The synchronizer mechanism for the transmission according to claims 2, wherein, a second thrust bearing is provided between the speed change gear and the clutch hub.

6. The synchronizer mechanism for the transmission according to claims 3, wherein, a second thrust bearing is provided between the speed change gear and the clutch hub.

7. The synchronizer mechanism for the transmission according to claim 1, wherein the second conical surface includes a movable conical surface formed at a rim portion of the speed change gear, and the third conical surface includes a fixed conical surface formed at an outer periphery of the synchronous torque assisting member.

8. The synchronizer mechanism for the transmission according to claim 2, wherein the second conical surface includes an movable conical surface formed at a rim portion of the speed change gear, and the third conical surface includes an fixed conical surface formed at an outer periphery of the synchronous torque assisting member.

9. The synchronizer mechanism for the transmission according to claim 3, wherein the second conical surface includes an movable conical surface formed at a rim portion of the speed change gear, and the third conical surface includes an fixed conical surface formed at an outer periphery of the synchronous torque assisting member.

10. The synchronizer mechanism for the transmission according to claim 4, wherein the second conical surface includes an movable conical surface formed at a rim portion of the speed change gear, and the third conical surface includes an fixed conical surface formed at an outer periphery of the synchronous torque assisting member.

11. The synchronizer mechanism for the transmission according to claim 5, wherein the second conical surface includes an movable conical surface formed at a rim portion of the speed change gear, and the third conical surface includes an fixed conical surface formed at an outer periphery of the synchronous torque assisting member.

12. The synchronizer mechanism for the transmission according to claim 6, wherein the second conical surface includes an movable conical surface formed at a rim portion of the speed change gear, and the third conical surface includes an fixed conical surface formed at an outer periphery of the synchronous torque assisting member.

13. The synchronizer mechanism for the transmission according to claim 1, wherein the synchronous torque assisting member includes a synchronizer piece.
